(19) United States
(12) Patent Application Publication
(10) Pub. No.: US 2021/0366461 A1
(43) Pub. Date: Nov. 25, 2021

(54) GENERATING SPEECH SIGNALS USING BOTH NEURAL NETWORK-BASED VOCODING AND GENERATIVE ADVERSARIAL TRAINING

(71) Applicant: Resemble.ai, San Jose, CA (US)

(72) Inventors: Zohaib Ahmed, San Jose, CA (US); Oliver McCarthy, San Jose, CA (US)

(21) Appl. No.: 17/326,176

(22) Filed: May 20, 2021

Related U.S. Application Data
(60) Provisional application No. 63/027,772, filed on May 20, 2020.

(51) Int. Cl. G10L 13/047; G10L 13/033; G10L 15/16

(52) U.S. Cl. CPC G10L 13/047; G10L 15/16; G10L 13/0335

(57) ABSTRACT

Systems and methods are described for generating speech signals using an encoder/decoder that synthesizes human voice signals (a “vocoder”). A processor may receive inputs that include a plurality of mel scale spectrograms, a fundamental frequency signal, and a constant noise signal. The received inputs may be encoded into two vector sequences by concatenating the received inputs and then filtering a result of the concatenating operation. A plurality of harmonic samples may be generated from one of the two generated vector sequences using an additive oscillator. The harmonic samples may be generated using processing steps that include applying a sigmoid non-linearity to the one of the two generated vector sequences. Each of the plurality of harmonic samples may then be used to create a vector, which may be used as an input for a convolutional decoder for adversarial training. The convolutional decoder may output the speech signals based on the vector made up of the plurality of harmonic samples.

### CROSS-REFERENCE TO RELATED APPLICATIONS

This application claims the benefit of U.S. Provisional Application No. 63/027,772, filed May 20, 2020, which is incorporated herein in its entirety.

### COPYRIGHT NOTICE

A portion of the disclosure of this patent document including any priority documents contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to generating speech signals using digital signal processing, and more specifically to using different artificial intelligence technologies to produce higher-quality speech signals.

### SUMMARY OF THE INVENTION

Systems and methods are described for generating speech signals using an encoder/decoder that synthesizes human voice signals (a “vocoder”). A processor may receive inputs that include a plurality of mel scale spectrograms, a fundamental frequency signal, and a voice/unvoiced sequence (“VUV”) signal. The received inputs may be encoded into two vector sequences by concatenating the received inputs and then filtering a result of the concatenating operation. A plurality of harmonic samples may be generated from one of the two generated vector sequences using an additive oscillator. In some embodiments, a noise generator may be applied to the other of the two generated vector sequences, to simulate “t’, “sh” and similar sibilant-type noises in samples of a noise signal. The plurality of harmonic samples may be generated using a series of processing steps that includes applying a sigmoid non-linearity to at least the one of the two generated vector sequences. For example, the non-linearity may be applied to an amplitude envelope of all signals, including the plurality of harmonics and the samples from the noise signal.

Each of the plurality of harmonic samples, together with the sibilant noise signal samples, may then be used to create an input vector, which may be used as an input for a convolutional decoder for adversarial training. The convolutional decoder may output the speech signals based on the input vector made up of the plurality of harmonic samples and the sibilant noise samples.

The systems and methods described herein generate higher-quality speech signals than conventional vocoders. This may be done by combining the harmonic samples generated by the encoder to create an input vector with more information than conventional vocoders to apply the model implemented by the convolutional decoder for adversarial training. In addition to the foregoing, in various embodiments the harmonic samples may be generated a sequence having predetermined frequency intervals, such as integer multiples of the fundamental frequency from the fundamental frequency signal.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 shows a simplified block diagram of a vocoder system for generating speech signals, according to an embodiment.

FIG. 2 shows a flow diagram of an exemplary method for generating speech signals in accordance with various embodiments of the present invention.

FIG. 3 shows a flow diagram of an exemplary method for generating harmonic samples using an additive oscillator, in accordance with various embodiments of the present invention.

FIG. 4 shows a flow diagram of an exemplary method for generating a sibilant noise signal for use in generating speech signals in accordance with various embodiments of the present invention.

FIG. 5 shows a flow diagram of an exemplary method for training a convolutional decoder using adversarial training, in accordance with various embodiments of the present invention.

FIG. 6 is a block diagram of an exemplary system for providing a directional deringing filter in accordance with various embodiments of the present invention.

### DETAILED DESCRIPTION

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Aspects of the one or more embodiments described herein may be implemented on one or more computers or processor-based devices executing software instructions. The computers may be networked in a peer-to-peer or other distributed computer network arrangement (e.g., client-server), and may be included as part of an audio and/or video processing and playback system.

Deep neural network-based vocoders have shown to be vastly superior in naturalness compared to traditional parametric vocoders. Unfortunately, conventional neural network-based vocoders may struggle with slow generation performance, due to their high complexity and auto-regressive generation. This may be addressed by reducing the number of parameters for the neural network model, thereby reducing the complexity, and/or by replacing the auto-regressive generation of the neural network with parallel generation. Most of these vocoders consume log mel spectrograms that are predicted by a text to acoustic model such as Tacotron. However, if there is sufficient noise in these predicted features, entropy increases in the vocoder creating artifacts in the output signal. Phase is also an issue. If a vocoder is trained directly with discrete samples (e.g., with a cross-entropy loss between predicted and ground truth samples) it can result in a characteristic “smeared” sound quality. This is because a periodic signal composed of different harmonics can have an infinite amount of variation in its discrete waveform while Sounding substantially identical. In this training scenario, the vocoder will be forced to “solve for phase”.

Differentiable Digital Signal Processing (“DDSP”) has shown that it is possible to leverage traditional DSP components like oscillators, filters, amplitude envelopes and convolutional reverb to generate convincing sounds, and that it can be done so without needing to explicitly “solve for phase.” DDSP generally includes an encoder that takes in log mel spectrograms as input, and a decoder that predicts sequences of parameters that drive an additive oscillator, noise filter coefficients (via spectra predictions), loudness distributions for the oscillator harmonics and amplitude envelopes for both the waveform, and noise. Finally the signal is convolved with a learned impulse response which in effect applies reverberation to the output signal. While this model excels at generating realistic non-voice sound signals, it has difficulty modeling speech because it cannot model highly detailed transients on the sample level, since the primary waveshaping components, i.e., the filter and envelopes, are operating on the frame level. Also, the sinusoidal oscillator generally does not generate convincing speech waveforms on its own.

Meanwhile, the Neural Source Filter (“NSF”) family of vocoders show that a fundamental frequency-driven source-excitation combined with neural filter blocks generates outputs with naturalness competitive with vocoders that only take log mel spectrograms as input. NSF may utilize two excitation sources, namely a fundamental pitch (F0) driven sinusoidal signal and a constant Gaussian noise signal, each of which are then gated by an unvoiced/voiced (UV) switch, filtered by a neural filter and passed through a Finite Impulse Response (FIR) filter.

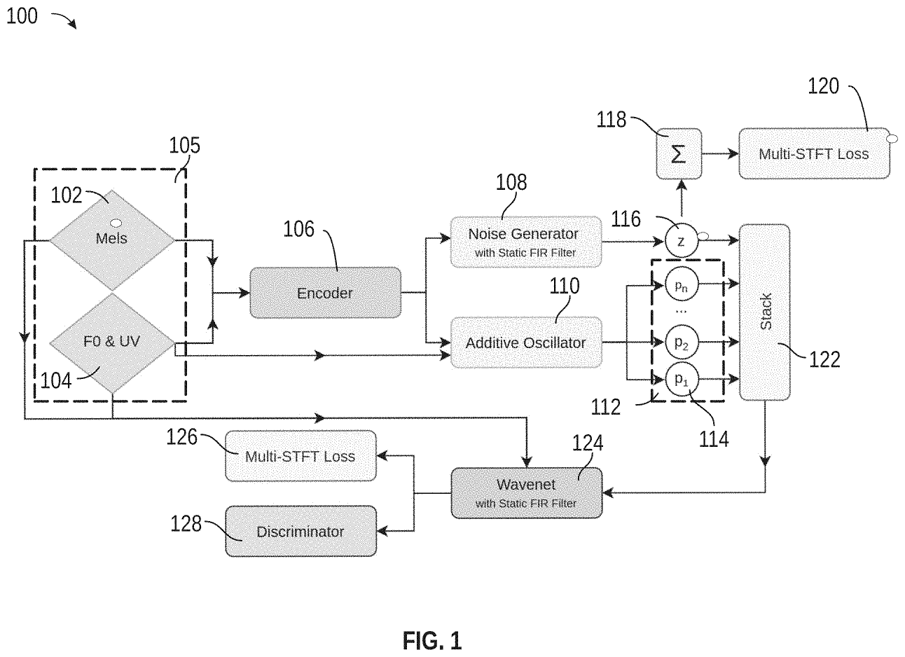

The present invention solves problems with conventional neural network-based vocoders by providing an efficient and robust model, that utilizes source excitation and neural filter blocks to improve speech signal quality. To improve naturalness, a discriminator module and adversarial training are also utilized. FIG. 1 shows a simplified block diagram of a vocoder system 100 for generating speech signals, according to an embodiment. The exemplary vocoder system 100 includes encoder module 106, which receives inputs 105 and generates vectors that are transmitted to noise generator module 108 and additive oscillator module 110. Inputs 105 may include log mel spectrograms 102 and a F0 frequency signal and a VUV gating signal 104.

The noise generator 108 may generate a noise signal z 116 from one of the vector outputs of the encoder module 106. The additive oscillator 110 may receive the other vector output of the encoder module 106, and may use the vector output to generate a sequence of harmonic samples 112, where each harmonic sample 114 is associated with a particular frequency. The sequence may be arranged using any suitable step, including integer harmonics based on integer multiples of the fundamental frequency (from the input fundamental frequency signal). The harmonic samples 112 may be stacked together with a noise signal z 116 into a single vector 122. This may be input into a deep neural network-based model for generating speech signals, implemented as Wavenet module 124, which uses a static FIR filter. While the neural network-based model 124 is shown as a Wavenet, any suitable deep neural network-based model may be used to generate the speech signals. Based on the vector 122 of harmonic samples and the log mel spectrograms 105, the Wavenet module 124 outputs speech signals, which are received by discriminator module 128. The discriminator module 128 may be a convolutional decoder trained using adversarial training, and may output speech signals based on the output of the Wavenet module 124, which are in turn based on the vector 122 of harmonic samples. In some embodiments, loss functions may be used to further improve the quality of the speech signals generated by the vocoder system 100. For example, the noise signal z 116 may be summed at block 118 to determine a multi-STFT loss 120, which may be adapted over time. This spectral (multi-stft) loss may be derived by transforming the model output speech signals and the corresponding groud truth signal (used in training) with STFT at various scales, and by mimimizing the distance between them using a neural network, for example. In an exemplary embodiment, a method called LSGAN (Least Squares Generative Adversarial Networks) may be used as the primary adversarial loss function. Similarly, a loss 126 may be determined for the output of the Wavenet module 124, and adapted over time to further improve the quality of the speech signals output by discriminator module 128. This feature matching loss may be derived by minimizing the difference between real and ground truth hidden activation features in a convolution network.

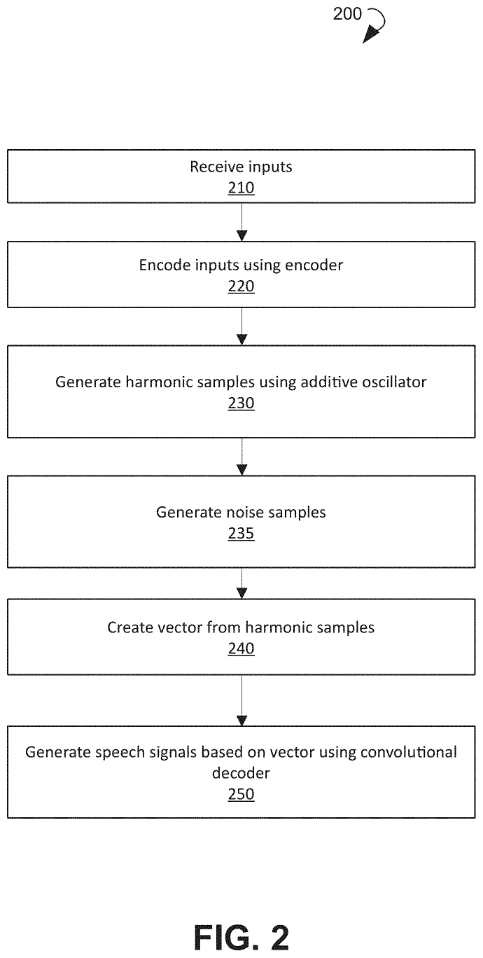

FIG. 2 shows a flow diagram of an exemplary method 200 for generating speech signals in accordance with various embodiments of the present invention. The exemplary method 200 may be implemented in a vocoder implementing the principles described herein, such as vocoder system 100. A processor, such as a processor in a computing system used to synthesize speech signals, may receive inputs that include a plurality of mel scale spectrograms, a fundamental frequency signal, and a VUV signal at step 210. The inputs may be represented as log mel spectrograms X_{îj}, an F0 pitch sequence fᵢ and a UV voicing sequence vᵢ, which may be extracted from the F0 pitch sequence fᵢ with:

$${v}_{\hat{i}} = \{ \begin{matrix}1 & if {f}_{\hat{i}} > 0 \\ 0 & otherwise\end{matrix} \qquad ( 1 )$$

Note that in equation (1), and for all subsequent equations, î is the time axis on the frame level, and i is the time axis on the sample level, while j will be used interchangeably for the channel/harmonic axes.

The received inputs may be encoded into two vector sequences by concatenating the received inputs and then filtering a result of the concatenating operation at step 220. This may be done, for example, by concatenating X_{îj}, fᵢ, and vᵢ into a vector C_{îj}, which may be processed by a convolutional neural network model. In an exemplary embodiment, the convolutional neural network model may include two 1d convolutional layers with 256 channels, a kernel size of 5 and LeakyRELU non-linearity. Then a fully connected layer of the encoder convolutional neural network model may receive the output of the 1d convolutional layers and output a sequence of vectors that is split in two along the channel axis [H_{osc},Hₙₒᵢₛₑ] for controlling both the oscillator 110 and noise generator 108.

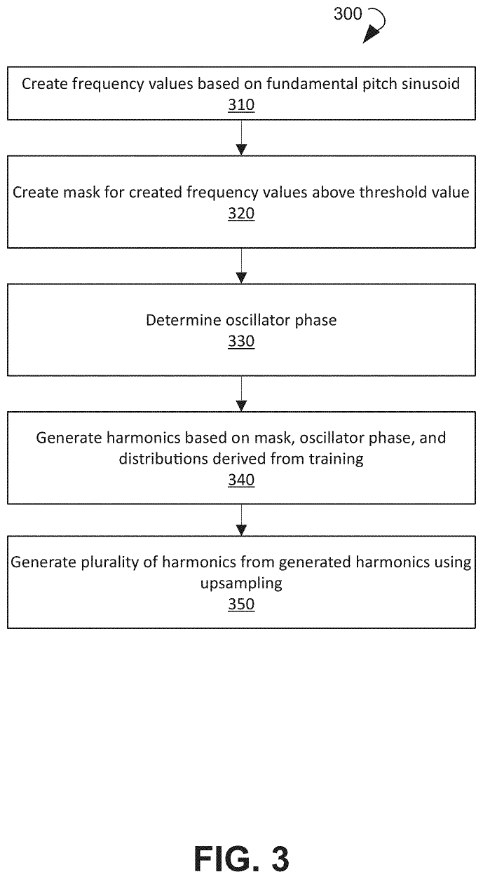

A plurality of harmonic samples may be generated from one of the two generated vector sequences using an additive oscillator at step 230. While several methods may be used to generate the plurality of harmonic samples, an embodiment is described below, in the discussion accompanying FIG. 3. FIG. 3 shows a flow diagram of an exemplary method 300 for generating harmonic samples using an additive oscillator (e.g., oscillator 110), in accordance with various embodiments of the present invention. The additive oscillator module 110 may receive vector H_{osc} from the encoder 106, transforms H_{osc} with a fully-connected layer and apply a modified sigmoid non-linearity, such as the non-linearity described in J. Engel, L. Hantrakul, C. Gu, and A. Roberts, “Ddsp: Differentiable digital signal processing,” 2020 (“Engel”), which is hereby incorporated by reference in its entirety. The additive oscillator module 110 may then use linear interpolation to upsample from the frame level to the sample level. The model parameters may then be split up into a sequence of distributions Aᵢⱼ for controlling the loudness of each harmonic and an overall amplitude envelope αᵢ for all harmonics. The distributions Aᵢⱼ constitute time-varying amplitude envelopes for each harmonic, which may assist in providing more information from which the speech signals may be derived.

Before generating the harmonics, predetermined frequency values Fᵢⱼ may be determined at step 310 for k harmonics by taking the input F0 sequence fᵢ, upsampling it to the sample-level with linear interpolation to get fᵢ, and multiplying the result with the integer sequence:

Fᵢⱼ=jfᵢ∀j∈[1,2,3, . . . ,k]. (2)

In some embodiments, before F0 sequence fᵢ is upsampled, the unvoiced segments off are interpolated in order to avoid glissando artifacts resulting from the quick jumps from 0 Hz to the voiced frequency.

At step 320, a mask Mᵢⱼ is created for all frequency values in Fᵢⱼ above 3.3 kHz, to prevent the Wavenet model from becoming an identity function early in training, where sound quality would not improve with further training. If s is the sampling rate:

$${M}_{ij} = \{ \begin{matrix}0 & if {F}_{ij} > ( 3300 / s ) \\ 1 & otherwise\end{matrix} \qquad ( 3 )$$

Based on the mask, the oscillator phase may be determined at step 330 for each time-step and harmonic with a cumulative summation operator along the time axis:

$${θ}_{ij} = 2 π {\sum }_{n = 1}^{i} {F}_{nj} . \qquad ( 4 )$$

Based on the mask, the oscillator phase, and the distributions derived above, the plurality of harmonics may be generated at step 340. In an exemplary embodiment, this may be done using:

Pᵢⱼ=αᵢMᵢⱼAᵢⱼ sin(θᵢⱼ+ϕⱼ), (5)

In equation (5), where ϕⱼ is randomized with values in [−π, π]. Finally, harmonics may be finalized at step 350 based on the harmonics generated at step 340. This may be done, for example, by eliminating the unvoiced part of the oscillator output Pᵢⱼ by upsampling v_{î} to vᵢ with nearest neighbours upsampling and broadcast-multiplying:

Oᵢⱼ=vᵢPᵢⱼ. (6)

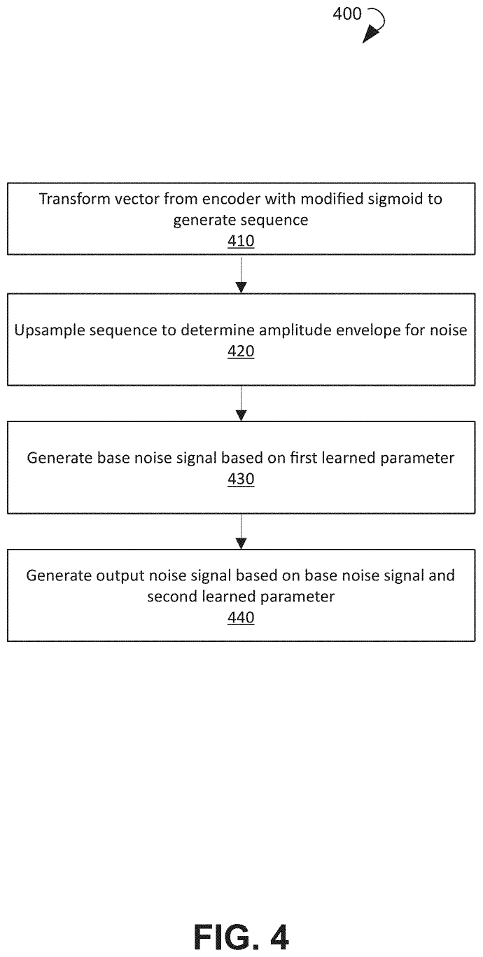

Noise samples from a noise signal may also be used as an input to the Wavenet module 124 at step 235. FIG. 4 shows a flow diagram of an exemplary method 400 for generating a noise signal for use in generating speech signals in accordance with various embodiments of the present invention. At step 410, a vector from the encoder 106 may be transformed with a modified sigmoid (a second sigmoid non-linearity, which may be the same as the sigmoid non-linearity used by the additive oscillator 110, or a different modified sigmoid) to generate an intermediate sequence. In the exemplary embodiment, the noise generator may take in Hₙₒᵢₛₑ from the encoder and transform it with a fully connected layer with the modified sigmoid described in Engel to sequence β_{î}.

The intermediate sequence may be upsampled using linear interpolation to determine a noise amplitude envelope at step 420. In the exemplary embodiment, sequence β_{î} may be upsampled with linear interpolation to the sample level to get βᵢ, the amplitude envelope for the noise. A base noise signal may then be generated based on a first learned parameter at step 430. For example, the output may be derived by with:

zᵢ=aβᵢnᵢ, (7)

In equation (7), α may be the first learned parameter, initialized with a value of (2π)⁻¹ and nᵢ˜ [symbol] (0,1). Finally, the output noise signal may be determined based on the base noise signal and a second learned parameter at step 440. This may be done, for example, by convolving zᵢ with a 257 length impulse response hₙₒᵢₛₑ with learnable parameters:

zᵢ=zᵢ*hₙₒᵢₛₑ. (8)

Returning to FIG. 2, each of the plurality of harmonic samples may then be used to create a vector at step 240, which may be used as an input for a convolutional decoder for adversarial training. This may be done by concatenating the stacked harmonics 112 from the oscillator Oᵢⱼ with shaped noise zᵢ 116, determined by method 400, to get Iᵢⱼ, which may be used as the direct input to the WaveNet module 124. The input vector C_{îj} may be upsampled with linear interpolation to output vector Cᵢⱼ, which in some embodiments may be used as side-conditioning in the residual blocks of the WaveNet module 124. Both the first and second learned parameters are may be learned internally in the model. α, a single value multiplier, may be given an initial value and then is modified unsupervised during training. In the exemplary embodiment, it may be set to ½π because standard Guassian noise is very loud and needs to be scaled back. As for β, it may be pretty random at the start of training. It may derived from the output of the encoder. Over time the encoder, may learn improved values for an amplitude signal/envelope for the noise. C is the mel spectrograms (or other acoustic features). These contain lots of information including timbre, texture, pitch, loudness, phonetic. Without this input the model would only have pitch and loudness information, thereby producing worse output based on having less input information. In an exemplary embodiment, performance may be improved by removing the gating function of the WaveNet module in favour of a simple tan h activation, and also by removing the residual skip collection. However unlike NSF, where the WaveNet channels are reduced to 1 dimension at the output of each stack, the amount of channels may be held constant throughout the neural network layers in an exemplary embodiment, to preserve the amount of information from the harmonic samples. For the WaveNet hyperparameters, 3 stacks may be used, each having 10 layers. The convolutional layers may have 64 channels and the kernel-size may be 5 with a dilation exponent of 2.

To obtain the final speech signals, at step 250 the output of the WaveNet wᵢ may be convolved by the convolutional decoder 128 with a 257 length learned impulse response hₒᵤₜₚᵤₜ to get the predicted output speech signals:

yᵢ=wᵢ*hₒᵤₜₚᵤₜ. (9)

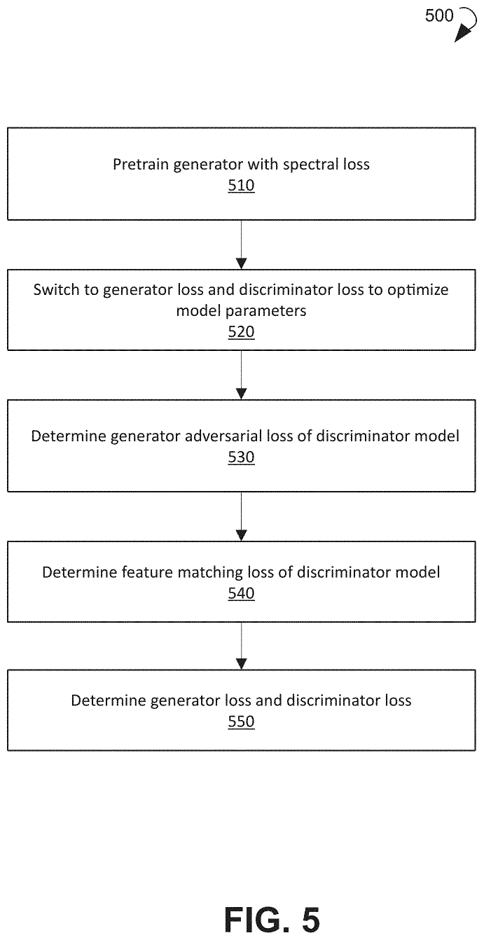

To improve the output, multi-short time Fourier transfer losses that are predetermined using a mathematical model optimized using training data may be applied to at least one of the input vector for the WaveNet and the output speech signals of the WaveNet. FIG. 5 shows a flow diagram of an exemplary method 500 for training a convolutional decoder using adversarial training, in accordance with various embodiments of the present invention. At step 510, the vocoder system (also referred to as a generator herein) is pretrained using just the spectral loss. At step 520, the generator loss and discriminator loss are utilized, to optimize the model parameters. The determination of those losses is detailed below, in steps 530-550. In an exemplary embodiment, a multi-STFT (Short Time Fourier Transform) loss similar for both the output of the WaveNet ŷᵢ and the WaveNet input Iᵢⱼ where a sum is determined along the stacked axis and the noise is added to get oᵢ a 1d signal:

$${o}_{i} = {\sum }_{j} {I}_{ij} . \qquad ( 10 )$$

From this the full generator adversarial loss of the discriminator module may be determined at step 530. This may be determined using equations (11) and (12):

$$\begin{matrix} {L}_{stft} = {L}_{mag} ( {y}_{i} , {o}_{i} ) + {L}_{mag} ( {y}_{i} , {y}_{i} ) , & ( 11 ) \\ {L}_{mag} ( y , y ) = \frac{1}{n} {\sum }_{n} ( \vert \vert \begin{matrix}{S}_{n} ( y ) & {S}_{n} ( y ) {\vert \vert}_{1} + \vert \vert \begin{matrix}{log S}_{n} ( y ) & {log S}_{n} ( y ) {\vert \vert}_{1} ,\end{matrix}\end{matrix} & ( 12 )\end{matrix}$$

In equations (11) and (12), yᵢ is the ground truth audio and Sn computes the magnitude of the STFT with FFT sizes n [2048; 1024; 512; 256; 128; 64] and using 75% overlap.

Next, at step 540, a feature matching loss of the discriminator model is determined. Multiple Mel-GAN discriminators Dₖ, k [1, 2, 3] of the exact same architecture may be used to get the generator's adversarial loss L_{adv} we use:

$${L}_{adv} = \frac{1}{K} {\sum }_{k} {‖ 1 - \hat{{D}_{k} ( {y}_{i} )} ‖}_{2} . \qquad ( 13 )$$

The generator's feature matching loss L_{fm}, where 1 denotes each convolutional layer of the discriminator model may be determined using:

$${L}_{fm} = \frac{1}{Kl} {\sum }_{k} {\sum }_{l} {‖ {D}_{k}^{l} ( {y}_{i} ) - \hat{{D}_{k}^{l} ( {y}_{i} )} ‖}_{1} . \qquad ( 14 )$$

A generator loss and a discriminator loss is determined at step 550. The final generator loss LG, with T=4 and L=25 to prevent the multi-STFT loss overpowering the adversarial and feature-matching losses may be determined using:

L_{G}=L_{sift}+τ(L_{adv}+λL_{fm}). (15)

Similarly, the discriminator loss may be determined using:

$${L}_{D} = \frac{1}{k} {\sum }_{k} ( ‖ \begin{matrix}1 & {{D}_{k} ( {y}_{i} ) ‖}_{2} + {‖ {D}_{k} ( {y}_{i} ) ‖}_{2} ) .\end{matrix} \qquad ( 16 )$$

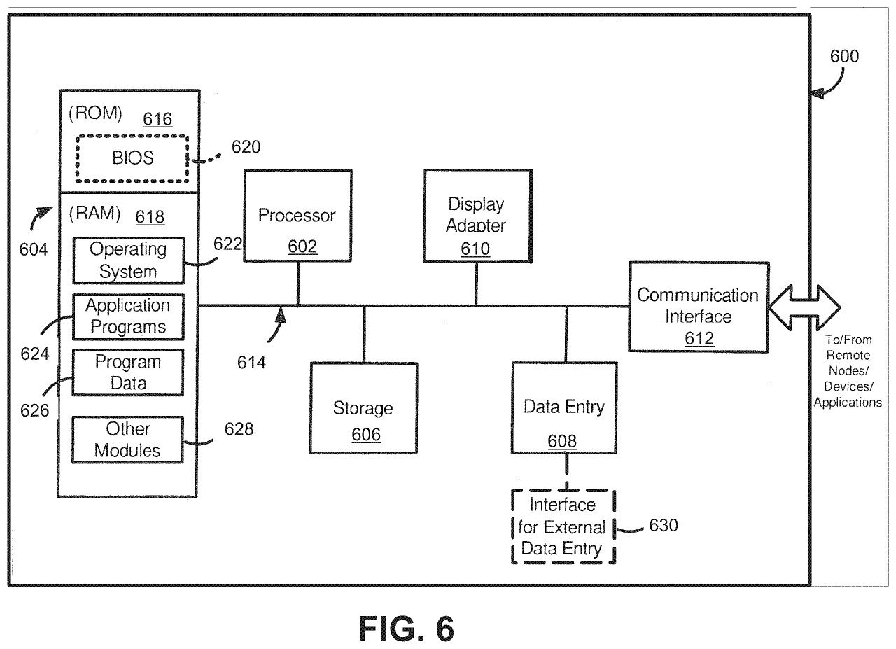

FIG. 6 is a block diagram of an exemplary system for providing a directional deringing filter in accordance with various embodiments of the present invention. With reference to FIG. 6, an exemplary system for implementing the subject matter disclosed herein, including the methods described above, includes a hardware device 600, including a processing unit 602, memory 604, storage 606, data entry module 608, display adapter 610, communication interface 612, and a bus 614 that couples elements 604-612 to the processing unit 602.

The bus 614 may comprise any type of bus architecture. Examples include a memory bus, a peripheral bus, a local bus, etc. The processing unit 602 is an instruction execution machine, apparatus, or device and may comprise a microprocessor, a digital signal processor, a graphics processing unit, an application specific integrated circuit (ASIC), a field programmable gate array (FPGA), etc. The processing unit 602 may be configured to execute program instructions stored in memory 604 and/or storage 606 and/or received via data entry module 608.

The memory 604 may include read only memory (ROM) 616 and random access memory (RAM) 618. Memory 604 may be configured to store program instructions and data during operation of device 600. In various embodiments, memory 604 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 604 may also include nonvolatile memory technologies such as nonvolatile flash RAM (NVRAM) or ROM. In some embodiments, it is contemplated that memory 604 may include a combination of technologies such as the foregoing, as well as other technologies not specifically mentioned. When the subject matter is implemented in a computer system, a basic input/output system (BIOS) 620, containing the basic routines that help to transfer information between elements within the computer system, such as during start-up, is stored in ROM 616.

The storage 606 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 600.

It is noted that the methods described herein can be embodied in executable instructions stored in a non-transitory computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 606, ROM 616 or RAM 618, including an operating system 622, one or more applications programs 624, program data 626, and other program modules 628. A user may enter commands and information into the hardware device 600 through data entry module 608. Data entry module 608 may include mechanisms such as a keyboard, a touch screen, a pointing device, etc. Other external input devices (not shown) are connected to the hardware device 600 via external data entry interface 630. By way of example and not limitation, external input devices may include a microphone, joystick, game pad, satellite dish, scanner, or the like. In some embodiments, external input devices may include video or audio input devices such as a video camera, a still camera, etc. Data entry module 608 may be configured to receive input from one or more users of device 600 and to deliver such input to processing unit 602 and/or memory 604 via bus 614.

The hardware device 600 may operate in a networked environment using logical connections to one or more remote nodes (not shown) via communication interface 612. The remote node may be another computer, a server, a router, a peer device or other common network node, and typically includes many or all of the elements described above relative to the hardware device 600. The communication interface 612 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 612 may include logic configured to support direct memory access (DMA) transfers between memory 604 and other devices.

In a networked environment, program modules depicted relative to the hardware device 600, or portions thereof, may be stored in a remote storage device, such as, for example, on a server. It will be appreciated that other hardware and/or software to establish a communications link between the hardware device 600 and other devices may be used.

It should be understood that the arrangement of hardware device 600 illustrated in FIG. 6 is but one possible implementation and that other arrangements are possible. It should also be understood that the various system components (and means) defined by the claims, described above, and illustrated in the various block diagrams represent logical components that are configured to perform the functionality described herein. For example, one or more of these system components (and means) can be realized, in whole or in part, by at least some of the components illustrated in the arrangement of hardware device 600. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 6. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for generating speech signals, the method comprising:
receiving, by a processor, inputs comprising a plurality of mel scale spectrograms, a fundamental frequency signal, and a voice/unvoiced sequence signal;
encoding, by the processor, the received inputs into two vector sequences, the encoding comprising concatenating the received inputs and then filtering a result of the concatenating;
generating, by the processor, a plurality of harmonic samples from one of the two generated vector sequences using an additive oscillator, the generating the plurality of harmonic samples comprising applying a sigmoid non-linearity to the one of the two generated vector sequences;
creating, by the processor, a vector comprising each of the plurality of harmonic samples; and
generating, by the processor using a convolutional decoder for adversarial training, the speech signals based on the vector comprising each of the plurality of harmonic samples.

2. The method of claim 1, the plurality of harmonic samples being generated in a sequence such that a frequency value of each harmonic sample after a first sample in the sequence is an integer multiple of a fundamental frequency from the fundamental frequency signal.

3. The method of claim 1, further comprising:
applying, by the processor, a second sigmoid non-linearity to the second of the two generated vector sequences to generate an intermediate sequence;
upsampling, by the processor, the intermediate sequence using linear interpolation to determine a noise amplitude envelope; and
determining, by the processor, a noise signal based on the upsampled intermediate sequence and an impulse response with learned parameters derived using a noise model.

4. The method of claim 1, the creating the vector further comprising concatenating the plurality of harmonic samples with a noise signal derived from the second of the two generated vector sequences, the vector being an output of the concatenating operation.

5. The method of claim 1, the convolutional decoder being a part of dilated convolutional neural network where a number of channels of the discriminator is held constant.

6. The method of claim 1, further comprising convolving an output of the convolutional decoder for adversarial training with a predetermined impulse response to generate the speech signals from the vector.

7. The method of claim 1, further comprising modifying at least one of a) the vector comprising each of the plurality of harmonic sample and b) the generated speech signals using a multi-short time Fourier transfer loss that is predetermined using a mathematical model optimized using training data.

8. The method of claim 1, the convolutional decoder applying a predetermined discriminator loss, generated using a mathematical model optimized using training data, in the generating of the speech signals.

9. A voice audio encoder comprising:
a memory; and
a processor, the processor executing instructions to:
receive inputs comprising a plurality of mel scale spectrograms, a fundamental frequency signal, and a constant noise signal;
encode the received inputs into two vector sequences, the encoding comprising concatenating the received inputs and then filtering a result of the concatenating;
generate a plurality of harmonic samples from one of the two generated vector sequences using an additive oscillator, the generating the plurality of harmonic samples comprising applying a sigmoid non-linearity to the one of the two generated vector sequences:
create a vector comprising each of the plurality of harmonic samples; and
generate, using a convolutional decoder for adversarial training, the speech signals based on the vector comprising each of the plurality of harmonic samples.

10. The encoder of claim 9, the plurality of harmonic samples being generated in a sequence such that a frequency value of each harmonic sample after a first sample in the sequence is an integer multiple of a fundamental frequency from the fundamental frequency signal.

11. The encoder of claim 9, the creating the vector further comprising concatenating the plurality of harmonic samples with a noise signal derived from the second of the two generated vector sequences, the vector being an output of the concatenating operation.

11. The encoder of claim 9, the convolutional decoder being a part of dilated convolutional neural network where a number of channels of the discriminator is held constant.

12. The encoder of claim 9, the processor further executing instructions to convolve an output of the convolutional decoder for adversarial training with a predetermined impulse response to generate the speech signals from the vector.

13. The encoder of claim 9, the processor further executing instructions to modify at least one of a) the vector comprising each of the plurality of harmonic sample and b) the generated speech signals using a multi-short time Fourier transfer loss that is predetermined using a mathematical model optimized using training data.

14. The encoder of claim 9, the convolutional decoder applying a predetermined discriminator loss, generated using a mathematical model optimized using training data, in the generating of the speech signals.

15. A computer program product comprising computer-readable program code to be executed by one or more processors when retrieved from a non-transitory computer-readable medium, the program code including instructions to:
receive inputs comprising a plurality of mel scale spectrograms, a fundamental frequency signal, and a constant noise signal;
encode the received inputs into two vector sequences, the encoding comprising concatenating the received inputs and then filtering a result of the concatenating;
generate a plurality of harmonic samples from one of the two generated vector sequences using an additive oscillator, the generating the plurality of harmonic samples comprising applying a sigmoid non-linearity to the one of the two generated vector sequences:
create a vector comprising each of the plurality of harmonic samples; and
generate, using a convolutional decoder for adversarial training, the speech signals based on the vector comprising each of the plurality of harmonic samples.

16. The computer program product of claim 15, the plurality of harmonic samples being generated in a sequence such that a frequency value of each harmonic sample after a first sample in the sequence is an integer multiple of a fundamental frequency from the fundamental frequency signal.

17. The computer program product of claim 15, the creating the vector further comprising concatenating the plurality of harmonic samples with a noise signal derived from the second of the two generated vector sequences, the vector being an output of the concatenating operation.

18. The computer program product of claim 15, the convolutional decoder being a part of dilated convolutional neural network where a number of channels of the discriminator is held constant.

19. The computer program product of claim 15, the program code further including instructions to convolve an output of the convolutional decoder for adversarial training with a predetermined impulse response to generate the speech signals from the vector.

20. The computer program product of claim 15, the program code further including instructions to modify at least one of a) the vector comprising each of the plurality of harmonic sample and b) the generated speech signals using a multi-short time Fourier transfer loss that is predetermined using a mathematical model optimized using training data.
